(19) United States
(12) Patent Application Publication
(10) Pub. No.: US 2014/0180744 A1
(43) Pub. Date: Jun. 26, 2014

(54) INTERFACE TO SELECT APPLICATION BASED ON STATE TRANSITION MODELS OF WORK

(71) Applicant: International Business Machines Corporation, Armonk, NY (US)

(72) Inventors: James R. Kozloski, New Fairfield, CT (US); Charles C. Peck, Newtown, CT (US); Clifford A. Pickover, Yorktown Heights, NY (US); Felicity Spowart, Morrisville, NC (US); Phillip R. Varker, Tuckahoe, NY (US)

(73) Assignee: International Business Machines Corporation, Armonk, NY (US)

(21) Appl. No.: 13/966,431

(22) Filed: Aug. 14, 2013

Related U.S. Application Data
(63) Continuation of application No. 13/723,551, filed on Dec. 21, 2012.

(51) Int. Cl. G06Q 10/06

(52) U.S. Cl. CPC G06Q 10/0633
USPC 705/7.15

(57) ABSTRACT

An application selection system for completing a work process includes an environment activity module that detects at least one event to determine an environmental activity occurring in an environment exposed to a user of the application selection system. A user activity module detects at least one user activity to determine at least one active state of the user. The application selection system further includes an application determining unit in electrical communication with the environment activity module and the user activity module. The application determining unit is configured to determine a passive state of the user, at least one work task included in the work process and a suitable application among a plurality of applications to execute the at least one work task.

### CROSS-REFERENCE TO RELATED APPLICATION

This application is a continuation of U.S. patent application Ser. No. 13/723,551, filed Dec. 21, 2012, the disclosure of which is incorporated by reference herein in its entirety.

### BACKGROUND

The present invention relates generally to an application selection system, and more specifically, to an application system that determines an application to be used by a user based on state transition models of a work flow process.

Computing devices are commonly utilized to complete work processes more efficiently. A user of the computing device may rely on various software applications to complete one or more work tasks included in the work process. When encountering a particular work task, the user must manually scroll/search for the appropriate software application that allows the user to complete the work task. However, an excessive number of applications stored may be available to the user, or the user may be involved in a work process that requires multi-tasking between an excessive number of open applications, or the user may not be familiar with the appropriate application's functions and so cannot immediately recognize it as relevant to the work task. In either case, manually searching/scrolling for the appropriate application to perform a particular work task wastes time. Further, a user may struggle to find the appropriate application needed to complete a work task, thereby delaying the completion of the work process.

### SUMMARY

According to an embodiment, an application selection system for completing a work process includes an environment activity module that detects at least one event to determine an environmental activity realized by a user of the application selection system. A user activity module detects at least one user activity to determine at least one active state of the user. The application selection system further includes an application determining unit in electrical communication with the environment activity module and the user activity module. The application determining unit is configured to determine a passive state of the user, at least one work task included in the work process and a suitable application among a plurality of applications to execute the at least one work task.

According to another embodiment, an application determining unit to determine an application among a plurality of applications for completing a work task includes a work task module that detects a current work task among a plurality of work tasks. The current work task is detected according to an environmental activity of a user performing the current work task. A passive state module determines an initial passive state among a plurality of transitional passive states of the user based on at least one of a user activity and the at least one environmental activity. The passive state module includes a transition module that transitions the initial passive state into an updated passive state based on transition probabilities associated with the plurality of transitional passive states. The application determining unit further includes an application module to determine a suitable application among the plurality of applications based on at least one of the updated passive state and the current work task.

In yet another embodiment, a method of determining a suitable application among a plurality of applications executed by a microcontroller for completing a work process comprises determining an environmental activity occurring in a user environment, and determining at least one active state of a user. The method further includes determining a passive state of the user and a current work task included in the work process. The method further includes determining the suitable application executable by the microcontroller among the plurality of applications based on the passive state and the current work task.

In still another embodiment, a computer program product comprises a tangible storage medium readable by a computer processing circuit. The storage medium stores instructions for execution by the computer processing circuit to perform a method of determining an application among a plurality of applications for completing a work task. The method includes determining a current work task among a plurality of work tasks based on an environmental activity of a user performing the current work task. The method further determines an initial passive state among a plurality of transitional passive states of the user based on at least one of a user activity and the at least one environmental activity. The method further includes transitioning the initial passive state into an updated passive state based on a transition probability associated with each transitional passive state. The method further includes determining a suitable application among the plurality of applications based on at least one of the updated passive state and the current work task.

Additional features are realized through the techniques of the various embodiments. Other embodiments and features are described in detail herein and are considered a part of the claims. For a better understanding of the various embodiments and features, refer to the description and to the drawings.

### BRIEF DESCRIPTION OF THE SEVERAL VIEWS OF THE DRAWINGS

The subject matter of the invention is particularly pointed out and distinctly claimed in the claims at the conclusion of the specification. The forgoing and other features of the embodiments are apparent from the following detailed description taken in conjunction with the accompanying drawings in which:

FIG. 1 is a block diagram illustrating an application selection system according to an embodiment;

FIG. 2 is a Markov diagram illustrating a transition model executed by the transition module included in the application selection system of FIG. 1 according to an embodiment; and

FIG. 3 is a flow diagram illustrating a method of selecting an application according to an embodiment.

### DETAILED DESCRIPTION

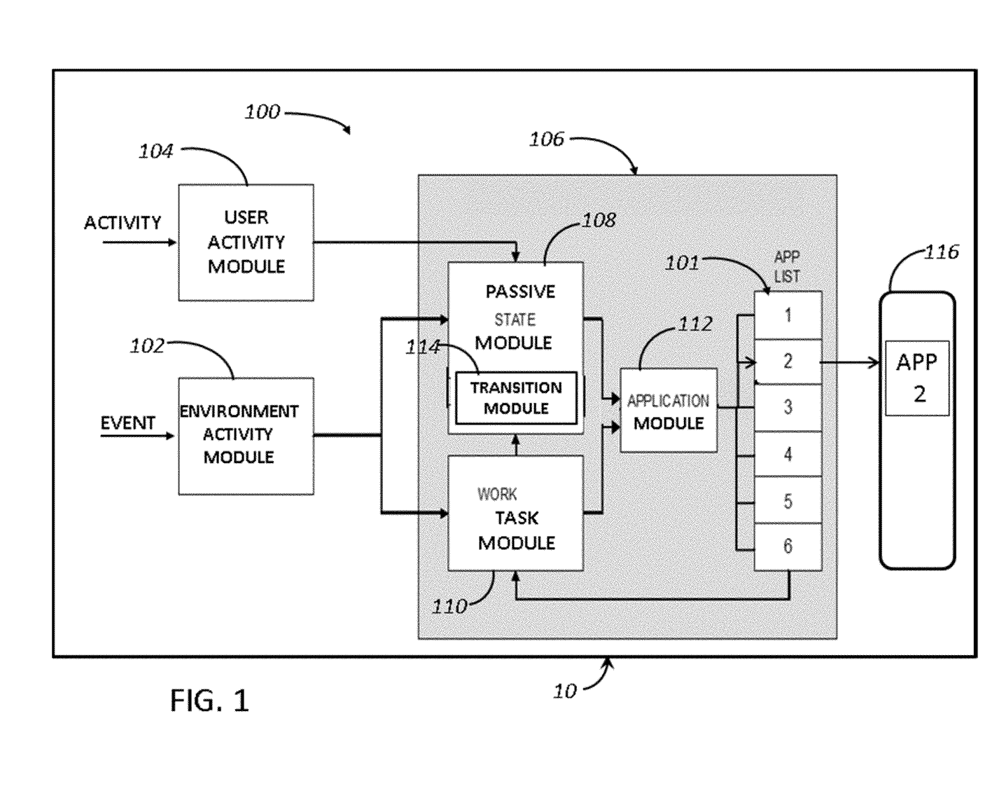

Referring now to FIG. 1, an application selection system 100 is illustrated according to at least one embodiment. The application selection system 100 may be implemented on a computing device 10 to determine a suitable application among a plurality of applications 101 for completing a work process that requires a user to undertake one or more work tasks. The computing device includes, but is not limited to, a personal computer (PC), a laptop computer, a tablet computer, a cellular telephone, a smart phone, a mobile digital media device, an image forming device, a personal digital assistant (PDA), and an integrated vehicle communications and entertainment system (IVCES) device. The applications may include, without limitation, a software application stored on a computing device or cloud storage network, and a mobile device software application “i.e., app,” downloaded from an app server to a mobile device.

The application selection system 100 includes an environment activity module 102, a user activity module 104 and an application determining unit 106. The modules may include logic embodied in hardware or firmware, for example, or may include a collection of software instructions that are executable by an electronic microprocessor. The software instructions may be written in a programming language including, but not limited to, Java, C, or assembly.

The environmental activity module 102 may detect at least one event. The detected event may be used to determine an environmental activity realized by the user. For example, the event may occur in a work environment exposed to a user of the application selection system 100. The at least one event includes, but is not limited to, recently used and/or downloaded software applications, incoming and/or outgoing telephone calls, received and/or sent emails, instant messages, voice mails, communication in a virtual universe, animated communication, video communication, and social media posts. In one embodiment, the event may also include a work task currently attended to by the user.

The user activity module 104 may detect at least one user activity to determine at least one active state of the user. The at least one user activity includes, but is not limited to, typing speed, typing errors, typing rhythm, biometrics, voice characteristics (in cases of voice mails), gesture recognition (in cases of video), biometrics of eye movements, biometrics from a mouse movement to identify user emotions, etc. The user activity module 104 may extract physiological and motor-behavioral measurements from mouse/keyboard/touch-screen actions and/or hand/gesture/voice characteristics. Such measurements can include biometrics derived from a keyboard or touch-screen to identify user emotions, emotion biometrics detected with items used by users (such as, for example, a necklace), user behavior, past user communications, emails, phone calls, etc. The user may also self-report emotional data using a using interface, which can be used to analyze correlations with these other measurements.

The eye movements include, but are not limited to, eye-behavior patterns, eye fatigue, eye-movement patterns, eye fixations over a period of time and saccades. Based on the eye movements, an active state of the user, such as fatigue, irritability, anxiety, excitement, etc., may be determined.

The keyboard biometrics include determining dwell times and flight times in the user communication in order to correlate typing rhythm with emotional states. Dwell times, as used herein, here refers to the amount of time a key is pressed (keystroke down to keystroke up). Flight times, as used herein, represent the periods of time between one keystroke down and the next keystroke down, and one keystroke up and the next keystroke up, which produce a rhythm unique to the user when typing.

The measurements and determined emotional states according to the user activity may be amassed in a database of the computer device 10, which is analyzed using standard statistical learning methods to find correlations and make predictions of a user's active state. These predictions may then improve with time, as more data is gathered and correlations analyzed.

The application determining unit 106 is in electrical communication with the environment activity module 102 and the user activity module 104. According to at least one embodiment, the application determining unit 106 is configured to determine one or more passive states of the user, one or more work tasks included in the work process, and a suitable application that allows a user to perform a current work task included in the work process.

The passive state of the user may be an unsupervised state, which is inconspicuous to the user. For example, the user may not indicate a current passive, nor indicate that current passive state is transitioning into a new and different passive state. Nonetheless, the passive state may still be determined and may lead to suggesting a suitable application to a user for performing a work task. The passive state and the work task may be determined by a passive state module 108 and a work task module 110, respectively. The passive state module 108 may determine a current passive state of the user among a plurality of transitional passive states. In at least one embodiment, the current passive state may be the initial passive state of the user existing at the onset of the work process.

The application determining unit 106 further includes an application module 112 that determines the suitable application among the plurality of applications based on the current work task and the current passive state. The current passive state of the user, however, may transition to an updated passive state, i.e., a new and/or different passive state, as the user's work environment changes. The current passive state of the user may also transition to an updated passive state if a new work task is presented to the user. Accordingly, the application module 112 may determine an updated suitable application according to the updated passive state and/or the new work task.

The transition between passive states may be achieved by a transition module 114 included in the passive state module 108. The transition module 114 transitions the current passive state into an updated passive state among the plurality of passive states. More specifically, the transition module 114 may be configured to transition between the plurality of passive states according to a Markov model. A Markov model is a well-known probability and statistical model based on a Markov property to predict reasoning, computations, decisions and state transitions. The Markov mode of the transition module 114 may include, but not limited to, a Markov chain, a hidden Markov model, a Markov decision process (MDP), a partially observable Markov decision process (POMDP), and a Markov random field.

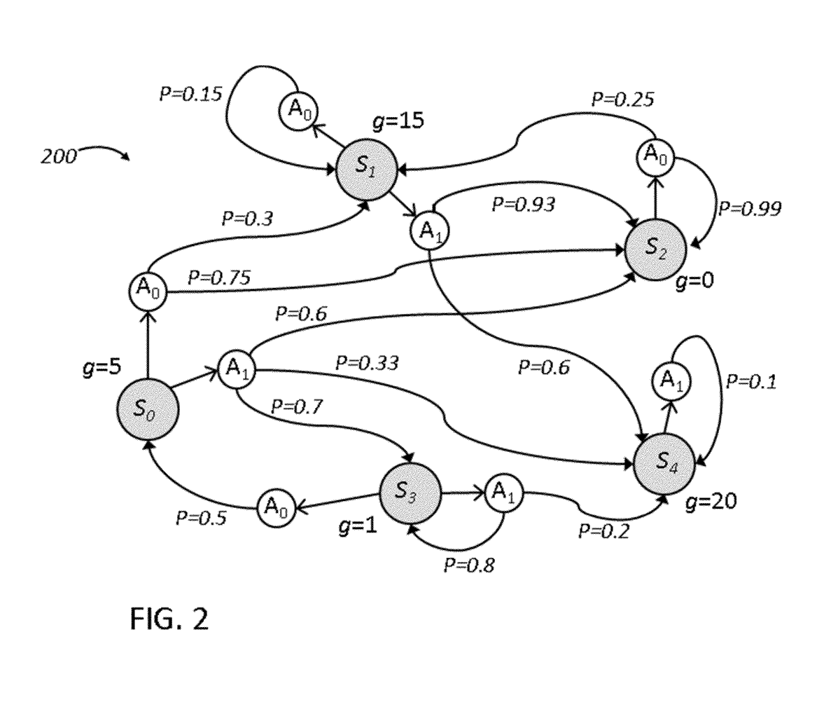

Referring to FIG. 2, an example of a MDP model 200 included in the transition model 114 for transition among a plurality of passive states is illustrated. The MDP model 200 includes a plurality of available passive states (S₀-S₄) of the user, a first event/action (A₀) available to the user, a second event/action (A₁) available to the user, and probabilities (P) of transitioning to each passive state (S₀-S₄). The probability (P) of transitioning to a new passive state (S′) from a current/initial state (S), (e.g., from S₀ to S′₃) given the existence of the two events/actions (A₀, A₁) may be expressed as:

Σ_{S′|∈S}P(S′|S,A_{X})=1.

The events/actions may include an environmental activity, the user's active state and the current work task. Accordingly, the transition module 14 may transition between a first passive state (S) and a second passive state (S′), for example, based on the environmental activity (A₀) and the active state of the user (A₁). Although not illustrated, the MDP model 200 may include more than two events/actions (A). For example, the MDP model 200 may include the environmental activity (A₀), the active state of the user (A₁), and the current work task (A₃) detected by the environment activity module 102. Based on the event/actions (A), determines a probability of transition to each passive state of the MDP model 200, and transitions to a particular passive state based on the probability. For example, the transition module 114 may determine the probability (P) corresponding to each available passive state (S₀-S₄), and may then compare each probability (P) to a predetermined threshold value (P_{TH}). If a particular passive state (S₀-S₄) exceeds P_{TH}, the transition module 114 determines the particular passive state as the updated passive state (S′), and passive state module 108 transitions from the current passive state (S) to the updated passives state (S′).

In another embodiment, the transition module 114 may determine a plurality of possible updated passive states (S₀-S₄), and may select the updated passive state (S′) based on a differential probability value (ΔP=P_{SX}−P_{TH}). For example, the transition module may obtain a plurality of differentials by calculating a difference between the probability of each possible updated passive state (P_{S0}-P_{S4}) and a threshold probability value (P_{TH}). Thereafter, the transition module 114 may select the updated passive state (S′) corresponding to the lowest differential probability value ΔP.

The MDP model 200 may also model the cost (g) of transitioning from a first passive state (S) to a second passive state (S′). Accordingly, the cost (g) may be a condition considered when predicting the second passive state (S′). The cost (g) may include, but is not limited to, speed of completing the work task with respect to the passive state, ease of completing the work task with respect the passive state, financial burden with respect to the passive state, etc. Referring to FIG. 2, the cost is indicated as ranging from a low cost (g=0) to a high cost (g=20).

In addition to transitioning from a current passive state (S) to an updated passive state (S′) among a plurality of passive states (S₀-S₄) stored in the transition module 114, for example, the passive state module 108 may update the transition module 114 with additional passive states. That is, the passive state module 108 may dynamically learn new passive states, which may be subsequently utilized to determine suitable applications for performing a work task. The probabilities corresponding to each passive state may be stored such that if a similar condition between a particular passive state, a user's active state, a work task and/or environmental activity occurs at a future date, the application module 112 may be able to quickly determine the appropriate suitable application for performing a particular work task.

As further illustrated in FIG. 1, the usage of a determined suitable application among a plurality of available applications may be determined by the work task module 110. More specifically, the work task module 110 may determine a current work task among a plurality of work tasks based on an environmental activity. For example, the work task module 110 may determine a new work task after the user completes the current work task.

The work task module 110 may also determine whether a suitable application determined by the application module 112 was utilized by a user to successfully complete the current work task. In one embodiment, when the user completes the work task using the determined suitable application, the work task module 110 outputs data informing the passive state module 108 that the determined suitable application completed the work task corresponding to the current passive state. Accordingly, the passive state module 108 my increase the probabilities associated with the passive state. However, if the user fails to complete the work task using the determined suitable application, or completes the work task using an application different from the determined suitable application, the passive state module 108 may decrease the probability associated with the current passive state. In addition, the work task module 110 may inform the passive state module 108 that the work task was completed using an application not initially included in the list of available applications 101. Accordingly, the passive state module 108 may update the passive state accordingly. In one embodiment, the available applications are not required to be currently open in a user's background, but instead need be only accessible to the user, such as stored in the memory of the computer device 10, or stored in a cloud server accessible by the computer device 10.

The work task module 110 may determine work tasks by monitoring working conditions of the user. For example, the work task module 110 may monitor various “open” applications in a multitasking environment. For example, the work task module 110 may detect that the user has a word-processer program open on his desktop in the form of an open or minimized window, an email program open, a photo-editing program open, etc. The work task module 110 may also determine the various applications that a user has available but not open, e.g., applications that are installed on the computer device 110, various applications that may be acquired, e.g., downloaded, in a time period (T_{DL} with respect to a predetermined time threshold T_{TH}), or applications that other users have used in a similar context to determine an ease at which the work task may be completed. The ease of a work task may be also be determined according to the nature and number of trial versions of software applications available based on T_{DL} with respect to a predetermined time threshold T_{TH}, or applications that the user has used within a threshold time T and cost C (e.g. recently, the user completed a similar task using a freeware software application). The determination as to the ease of accessing a work task may be performed in a graduated fashion based on various factors including, but not limited to, whether the application is on the user's system, whether the application is currently open or not open, whether the application is stored on a remote cloud system, or the time as to when the application was last used, e.g., whether the user accessed the application within the past day or within a time period T.

The work task module 110 may also predict a work flow process based on the timing of a user's use of applications as a function of time, day of the week, etc., and/or the content of a document or audio message associated with various work. Accordingly, the work task module 110 may further predict future work tasks over a time period (T). For example, if a user is reading an email with an attachment, and is conducting a telephone conversation with a person who previously sent the user an email, the work task module 110 may predict that the user will open the document with a 70% probability (i.e., P=0.7*100%), and then open the email. Accordingly, an email may be prepared, including adding the caller as the recipient, attaching the caller's previously sent email, adding the subject, etc., such that the user may quickly and conveniently reply to the caller.

The application selection system 100 may further include a user interface that alerts the user to the suitable application. The user interface may comprise, for example, a graphic user interface (GUI) 116. The user interface may also be capable of detecting one or more inputs and alerting the user via one or more outputs. For example, the inputs may include a mouse, a touchpad, a touch screen, a keyboard, etc. Accordingly, the user interface may detect various events, such as at least one input indicating the usage of the suitable application. The GUI 116 may also include a camera that may perform facial recognition, and a microphone that may detect conversations between colleagues located in the user's work environment. The outputs may include outputting a sound via a speaker network and/or a graphic on a display. In at least one embodiment, the determined suitable application may be displayed to the user on the display of the GUI 116. The suitable application may also be displayed in a manner that is unobtrusive to the user. For example, upon determining the suitable application, the GUI 116 may emphatically display an icon at a bottom portion of the display. The icon may also be displayed semi-transparently on the GUI 116. The GUI 116 may also alert the user of a suitable application using a sound, such that the information on the display is not obstructed. Accordingly, the user may be alerted of the suitable application in various ways while not obstructing the content on the display.

Although not illustrated, at least one embodiment allows an application selection system 100 of one user to share information with a different application selection system 100′ of a different user. For example, a first mobile device may suggest a suitable application to a second mobile platform located remotely from the first mobile device when the second mobile device is experiencing a similar work task previously experienced by the first mobile device. Accordingly, the second mobile device may alert the second device user of the suitable application already stored on the second mobile device, or may dynamically alert the second device user to download the suitable application from a data server storing the suitable application.

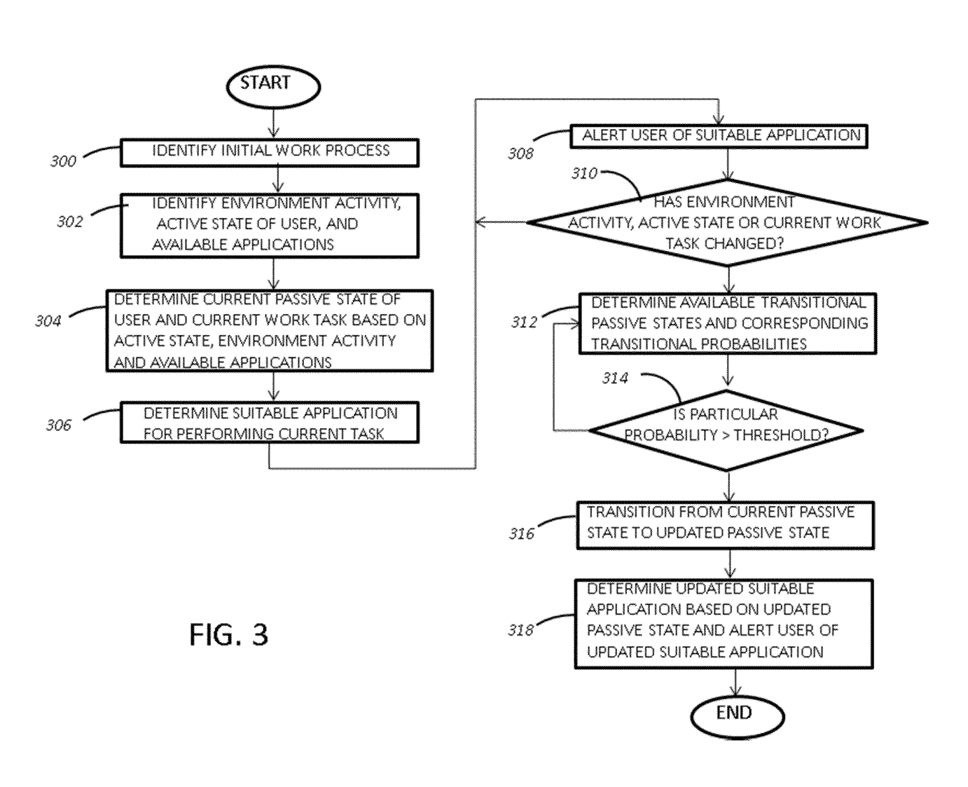

Referring now to FIG. 3, a flow diagram illustrates a method of selecting an application according to an embodiment. At operation 300, an initial work flow process is identified. The work flow process includes one or more work tasks to be completed by a user. For example, a work process may be a project status meeting including one or more work tasks, such as sending an email, initiating a telephone conversation, updating a calendar entry, discussing a slide presentation, etc. At operation 302, an environment activity, an active status of the user and one or more open applications available to the user are identified. The environment activity may be determined by detecting one or more event occurring in a user's work environment such as incoming and/or outgoing telephone calls, received and/or sent emails, instant messages, voice mails, etc. The active states of the user may include without limitation a fatigued state, an excited state, an agitated state. The active state of the user may be determined by detecting one or more user activities including, but not limited to, mouse clicks, eye-behavior patterns, etc. The available applications may include applications that are currently, and also applications that may not be opened, but are stored on a computer device used by the user. At operation 304, a current passive state of the user and a current work task is determined. The current passive state of the user may include an initial state of the user, and may be a state inconspicuous to the user. The work task may be determined according, for example, the various opened applications. Accordingly, a suitable application for performing the current work task may be determined at operation 306, and the user may be alerted to the suitable application at operation 308.

At operation 310, a determination is made as to whether the user's environment has changed. For example, a telephone call may interrupt the user during performance of a current work task, which would indicate a change in the user's environment. In addition, the telephone call may place the user in an agitated state, which may be detected according to an increase in speed and frequency of the user's mouse clicks or a detection of erratic eye-pattern behaviors. Further, a change in work task may be determined if a user completes the current work task and begins a new work task. If none of the user's environment, active state or work tasks changes, the user continues to be alerted of the suitable application. Otherwise, a transition in the passive state of the user is determined at operation 312 based on the available transitional passive states and the probability corresponding to each available passive state. At operation 314, each probability is compared to a predetermine threshold value. If a probability is less than the threshold value, another probability is determined at operation 312. If a probability exceeds the threshold value, current passive state is transitioned to a new passive state, i.e., the passive state corresponding to the probability that exceeds the threshold value, at operation 316. At operation 318, an updated suitable application is determined based on new passive state. The user is then alerted of the updated suitable application and the method ends.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The flow diagrams depicted herein are just one example. There may be many variations to this diagram or the operations described therein without departing from the inventive concept. For instance, the operations may be performed in a differing order or steps may be added, deleted or modified. All of these variations are considered a part of the claims.

In general, the term “module”, as used herein, refers to logic embodied in hardware or firmware, or to a collection of software instructions, written in a programming language including, but not limited to, Java, C, or assembly, and which is executed by a microprocessor. One or more software instructions in the modules may be embedded in firmware, such as, for example, in an EPROM, and/or stored in any type of non-transitory computer-readable medium or other storage device.

While various embodiments have been described, it will be understood that those skilled in the art, both now and in the future, may make various modifications which fall within the scope of the following claims. These claims should be construed to maintain the proper protection of the claims recited below.

What is claimed is:

1. A method of determining a suitable application among a plurality of applications executed by a microcontroller for completing a work process, the method comprising:
determining, with an electrical sensing unit, an environmental activity occurring in a user environment;
determining at least one active state of a user operating the microcontroller;
determining a passive state of the user and a current work task included in the work process; and
determining the suitable application executable by the microcontroller among the plurality of applications based on the passive state and the current work task.

2. The method of claim 1, further comprising:
determining a current work task based on the environmental activity;
determining a current passive state among a plurality of transitional passive states;
determining the suitable application among the plurality of applications based on the current work task and the current passive state;
and alerting the user of the suitable application via a graphic user interface.

3. The method of claim 2, further comprising determining an updated passive state based on transition probabilities assigned to each passive state and transitioning the current passive state to the updated passive state in response to the corresponding transition probability exceeding a threshold value.

4. The method of claim 3, further comprising detecting a usage of the suitable application, and updating the transition probability corresponding to the updated passive state based on the usage.

5. The method of claim 4, further comprising determining an updated suitable application based on the updated passive state and alerting the user of the updated suitable application via the graphic user interface.
